(19) United States
(12) Patent Application Publication
(10) Pub. No.: US 2007/0189518 A1
(43) Pub. Date: Aug. 16, 2007

(54) 3-D quaternion quantum fractal encryption

(76) Inventor: Richard A. Nanni, Benzonia, MI (US)

Correspondence Address: EDWIN TARVER, 16830 Ventura Blvd., SUITE 360, Encino, CA, 91436, US

(21) Appl. No.: 11/395,398

(22) Filed: Mar. 30, 2006

Related U.S. Application Data
(60) Provisional application No. 60/666,806, filed on Mar. 30, 2005.

(51) Int. Cl. H04L 9/30

(52) U.S. Cl. 380/30

(57) ABSTRACT

An encryption method based on a controlled permutation algorithm using a three-dimensional quaternion quantum fractal image to establish a nearly infinite range of data from which encryption keys can be derived. The data of the fractal is converted at base 16 to yield millions of possible combinations for each pixel of the image, identified using only ten symbols in standard Unicode format. The encryption technique employs pointers and parameters to transmit key data rather than actual keys, lowering processor overhead. The result is encryption designed for computer applications that is government standard compliant and capable of withstanding brute force attacks from existing super-computers and quantum computers of the future.

### CROSS-REFERENCE TO RELATED APPLICATIONS

This is a utility patent application which claims benefit of U.S. Provisional Application No. 60/666,806 filed on Mar. /30/2005.

### FEDERALLY SPONSORED RESEARCH

Not Applicable

### SEQUENCE LISTING OR PROGRAM

Not Applicable

### BACKGROUND

This invention relates to the field of encrypting computer data, and more specifically, to a method of encrypting data using a randomly generated three-dimensional quaternion chaos fractal image.

Advances in computer technology continue to render encryption methods obsolete. Even recently developed techniques have been unsuccessful at preventing super-computer decryption. With the development of quantum computers on the horizon, there is a need for a system that can encrypt data securely and withstand brute force attacks by computers of both the present and future.

The present invention provides a one million bit to terabit multi-key encryption method that can be deployed today on standard computers. It is an encryption system based on math and chaos theory, employs three-dimensional quaternion fractal image generation as the basis for the encryption/decryption key, and provides encryption that is not solvable by brute force attack.

Pat. App. No. 20040202326 to Chen discloses a method for real-time encryption of digital images using chaotic maps. It employs a chaotic map along with a family of generalized chaotic maps to shuffle special positions for key generation. Similarly, U.S. Pat. No. 6,792,111 to Italia discloses a real-time encryption system for information transmitted through packet switching networks. This method masks data by combining it at the transmitting station with an encryption code before transmitting the data through the network. Neither of these inventions employs a standard controlled permutation in order to maintain cryptographic security as in the present invention. They are also susceptible to brute force decryption.

Pat. App. No. 20030118185 to Lambert discloses a method for encryption in which bytes or blocks of data are encrypted through a plurality of changing algorithms. Changing an algorithm is carried out by applying a chaotic or catastrophic equation. By contrast, the present invention employs the generation of a three-dimensional quaternion quantum fractal image to provide data from which decryption pointers and keys can be selected.

Finally, Pat. App. No. 20030182246 to Johnson, et al., relates to the application of techniques based upon the mathematics of fractals and chaos in various fields including document verification, data encryption and weather forecasting. The invention also relates, in one of its aspects, to image processing. Although this invention relates to the application of fractals in data encryption applications, it anticipates encryption based on a pseudo-random number sequence generated in accordance with an algorithm created through chaos fractals.

By contrast, the present invention relates to the application of techniques based upon the mathematics of fractals and chaos in the generation of infinitely variable decryption keys and pointers.

The present invention improves on the prior art by employing a randomly generated three-dimensional quaternion fractal image to produce an unpredictable, infinitely modifiable matrix. It does not require the passing of actual keys from point to point, but rather passes encrypted pointer parameters which must be implemented into the proper image or images. Multiple images can be used to generate a key matrix. For instance, a user could use ten separate images and extract one key from each image to generate the total key matrix. When properly implemented, these pointers define the beginning and ending points of multiple keys, extracted from the specific image used for the initial encryption.

Through standard controlled permutations, the method of the present invention maintains its cryptographic security in a manner similar to the CIKS-1 and SPECTR-H64 block cipher encryption algorithms. It is a standard Feistel block cipher, with a structure similar to the Data Encryption Standard and is designed for use in software applications.

In addition, the present invention is the only encryption method that automatically passes all data from point to point through an encrypted multi-threaded tunneling virtual private network (VPN) using different internally generated random encryption keys for each VPN instance. Because only the pointers are transmitted with the file, and not the actual keys, the system requires minimal processor resources. For instance, a typical one million bit key would constitute 192 kilobytes of data, but by using only pointers, the transmitted data is reduced to less than 1 kilobyte. In addition, even if the pointers are decrypted, they are useless without the exact fractal image used to generate the original pointers.

This method is also well suited for use by United States government agencies, since it meets approved Federal Information Processing Standard guidelines as established by the National Institute of Standards and Technology.

### SUMMARY

The present invention discloses an encryption method addressing and capitalizing on advancements to known enhanced encryption processes. It uses multiple keys, each of which may be of a different length. It also supports any length key up to 16,384 bits per key. It can accommodate any block size from four to 17,179,869,184 bits, and avoids the necessity of passing the actual keys with encrypted data, since the encrypted multi-threaded tunneling VPN passes only encrypted key parameters and pointers, then the data. Finally, the method uses a randomly created two or three-dimensional quaternion quantum, or other fractal image as the basis from which the keys are generated.

The actual structure of an individual fractal image is inconsequential. Rather, the encryption method of the present invention relies on the fact that the variable structure of each fractal results in a different matrix from which an infinite number of random data bits can be derived. Because fractals are, mathematically, the result of chaos theory, they are always random and non-predictable. Furthermore, the pointers in the fractal data can be addressed from any of the six sides of the three-dimensional image and at any start and stop point at any depth.

The invention converts color codes extracted from a three-dimensional fractal image, and uses them as part of the keys. Normally, these codes are different numbers of integers. However, by taking them to a base 16 numbering system, they all become seven integer codes. Using codes based on the fractal image, 16.7 million possible combinations of data can be represented with only ten symbols. Therefore, an almost infinite number of permutations for each key can be obtained in any given image or set of images.

Furthermore, the encryption technique does not require the actual keys to pass from point to point with the data. Rather, it only passes encrypted pointer parameters that are then implemented into the fractal image. These pointers define the beginning and ending points of multiple keys, which are then extracted from the fractal image used in the initial encryption.

It automatically passes all data from point to point via an encrypted multi-thread tunneling VPN, using a different internally generated random encryption key for each VPN instance. Because the transmission contains only the pointers for an encrypted file and not the actual keys, the system uses fewer processing resources. In addition, the pointers are useless without the original fractal image of which there are infinite random variations.

The invention uses a standard controlled permutation in order to maintain its cryptographic security, as in CIKS-1 and SPECTR-H64 algorithms. The algorithm is a standard Feistel block cipher, similar to the Data Encryption Standard, and designed for use in software applications and meets approved government standards for security. These and other features, aspects, and advantages of the present invention will become better understood with reference to the following drawings and description

### BRIEF DESCRIPTION OF THE FIGURES

FIG. 1 is a black and white representation of a color fractal image. In the actual color fractal of the invention, a nearly infinite number of data points exist.

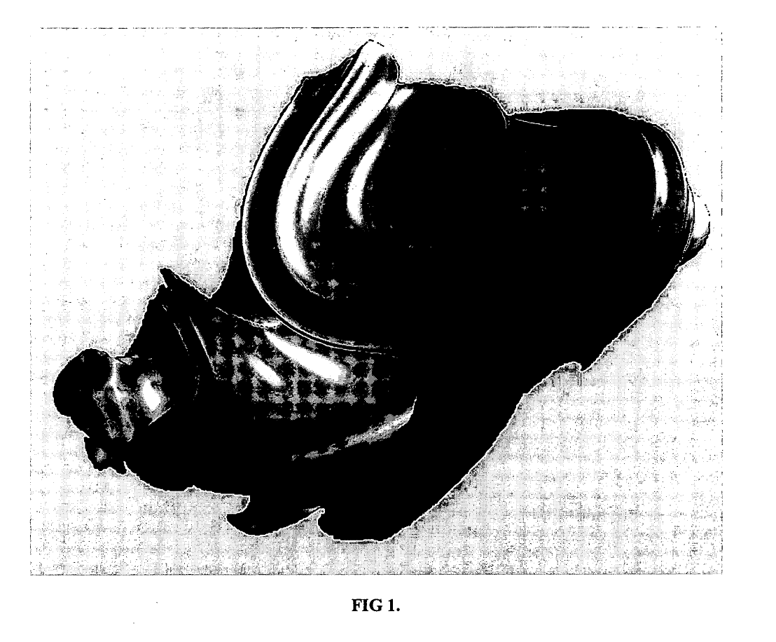

FIG. 2 is an example of a simple parameter generation. This parameter would also be encrypted for transmission.

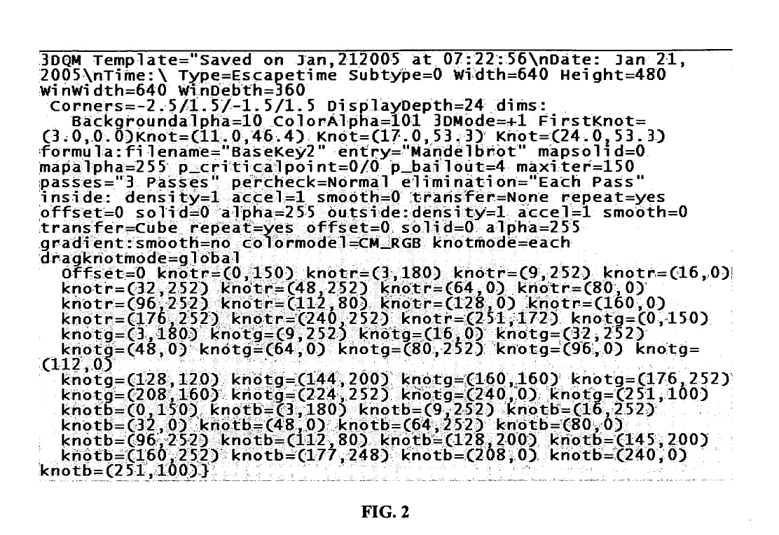

FIG. 3 shows an example of actual data that would be transmitted across the Internet, including the data and the key generation pointers.

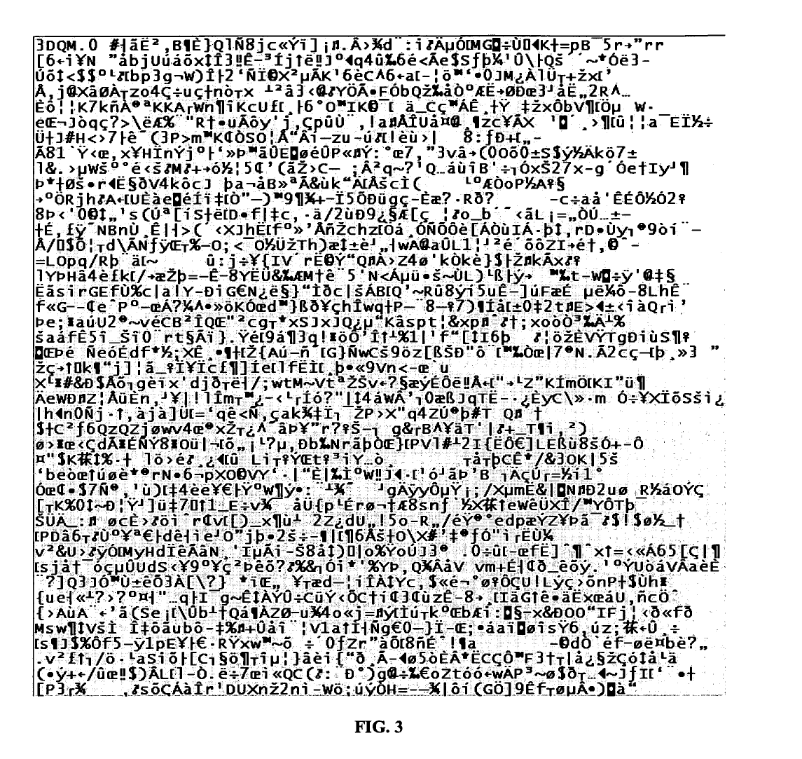

### DESCRIPTION

Encryption of Data:

Three-dimensional quaternion quantum fractal encryption is based on randomly generated quaternion chaos fractals. A quaternion chaos fractal can be of infinite size and have an infinite number of occurrences for each of over twenty-five available variables.

Fractal variables include: the shape of the area, color mapping, number of colors, exact shading of colors, resolution, precision, internal cubic mapping of the image, external cubic mapping of the image, cube root mapping of the image, acceleration, smoothing, wrapping, angle, offset, speed, step, Mandelbrot chaos base formula, number of passes, periodicity, elimination, critical point, bailout value, angles, and color cycling to include speed, stepping, and direction.

In addition, other variables affecting the image are the light direction, both horizontal and vertical, light intensity, light diffusion, ambient light and reflected light. Transformations can include up/down, multiplier, y-stretch and back multiplier. Open G1 data includes view, distance, rotation and x/y parameters. Material parameters include secular, emission, color, alpha, shininess, and texture settings in spherical mode.

Each of the variables associated with the fractal is assigned a base sixteen value using a binary code between 00 and FF. These binary values can be repeated an infinite number of times at infinite locations within the fractal with no repeating pattern of any kind. When a single pixel is pinpointed, a random color code, identified by its binary value, is produced. The random base 16 color codes are then converted to a standard Unicode format, providing a unique number for every character in any platform, program, or language. This conversion generates the keys used to encrypt the data.

Using the color codes based on the fractal image data, 16.7 million possible combinations of data for each pixel in the image are possible using only ten symbols. By converting the color codes in this manner, a nearly infinite number of permutations for each key can be obtained in any given image. For instance, a 2048×2048 pixel image at 300 DPI yields 2.10135×10¹⁷ possible combinations for each bit of the key. When multiplied by a one million-bit key, 2.10135×10²⁶ possible permutations for each key are possible. If multiple images are used, the possible permutations grow even larger.

Data Transmission and Retrieval:

When transmitting encrypted files, the system automatically passes all data from point to point through an encrypted multi-threaded tunneling VPN using a different internally generated random encryption key for each VPN instance. Because only the pointers are transmitted with the file and not the actual keys, the system requires minimal resources.

Whereas a typical one million-bit key could constitute 192 kilobytes of data, the transmitted data is reduced to less than one kilobyte by using only pointers. Furthermore, without the exact image used to generate the original pointers, the pointers are useless even if decrypted. In addition, the transmitted data itself is encrypted by the unique instance encryption of the VPN.

After transmission, when a key is to be regenerated, the unique quaternion chaos fractal image is generated from the base parameters and a search is performed inside the fractal for the appropriate address pixels containing the first and last values in the key string. When they are found, a set of pointers is created indicating the pattern needed to navigate inside the fractal to generate all of the required keys to decrypt the specific data.

If even greater complexity is required, a different fractal parameter set, and pointers completely unrelated to the original data can be used. Using this encryption technique, there is no way to extract the data from the parameters and pointers without having the specific fractal image used for that session, the specific set of pointers and parameters to generate the keys and the keys to decrypt the data. Combining the set of pointers with any other fractal image will result in a completely different set of useless data.

As an example of keys used in this encryption technique, consider a spreadsheet and a small manually generated matrix of twenty-six vertical and horizontal cells labeled A through Z and 1 through 26, with twenty-six sheets of these cells in the file. We now have a matrix of cells on each sheet, where each cell contains a random ASCII character.

A key may be generated, starting on sheet one at C20 and ending it on sheet twenty-six at C20. The next key might start on sheet one at D1 and end on sheet one at D26. The third key could start on sheet 26 at X12 and end on sheet one at X12 and so forth. A three-dimensional quaternion fractal image is 5.1029×10³³ more complex than the spreadsheet of this example.

In addition to the sheer size of the fractal, other elements of the system make attempting to decipher an encrypted file extremely difficult. For instance, each key can be any length, and any number of keys can be used. Furthermore, each file can be encrypted using a different randomly generated fractal containing completely different parameter values. This renders any set of parameters and pointers useless unless the specific fractal pertaining to those parameters and pointers is addressed. If the same file is repeatedly encrypted, even trillions of times, a different set of parameters and pointers will result for each session.

Finally, the method of the present invention is a unique encryption system, in that the actual key is never exchanged, but rather merely referenced by parameters and pointers. These small pieces of encrypted data generate the keys, ensuring that even if the encrypted file has fallen into the wrong hands, there will be no way of extracting the original data. The invention presents the only system currently capable of withstanding a brute force attack from quantum computer platforms currently in development, eliminating the possibility that collected encrypted data might be held and deciphered by machines and methods developed in the future.

Interface Issues:

The three-dimensional quaternary quantum fractal encryption of the present invention employs a standard controlled- permutation to maintain cryptographic security, similar to the well known CIKS-1 and SPECTR-H64 block cipher encryption algorithms. This specific algorithm was chosen because of its ability to handle extremely large blocks of data (up to full size) making it extremely fast while taking up fewer processor resources, and is ideal for digital signal processing or application-specific integrated circuits developed in the future.

Specifically, the present invention uses a standard symmetric algorithm with true variable block sizes as small as 64 bits, and as large as 17,179,869,184 bits. The system varies this process by using multiple keys, which are from 128 to 256 bits and typically consist of nine keys extracted from the fractal image. The minimum size of the fractal is 256 pixels square, and is limited in size only by available memory and memory swap space. The result is a minimum million bit aggregate key.

The algorithm itself is a standard Feistel block cipher, similar to the Data Encryption Standard. It takes a 64-bit plaintext and splits it, creating two 32-bit halves. Those 32-bit pieces are then mixed with the nine variable length keys extracted from the quadratic matrix.

The right 32-bit half and a 60-bit sub key are fed into the function F. The output is then XORed. The left part of the key and the halves are swapped in the transformation stage of the algorithm. This process is repeated for 16 rounds. However, the swap is omitted in the final round before the cipher text is produced. The strength of the algorithm is therefore centered around the F function. The decryption process is the same.

In three-dimensional quaternion quantum fractal encryption, the 32-bit plaintext, using a function E, is expanded in four 10-bit values in the following manner:

E1=P₁P₀P₃₁P₃₀P₂₉P₂₈P₂₇P₂₆P₂₅P₂₄

E2=P₂₅P₂₄P₂₃P₂₂P₂₁P₂₀P₁₉P₁₈P₁₇P₁₆

E3=P₁₇P₁₆P₁₅P₁₄P₁₃P₁₂P₁₁P₁₀P₉P₈

E4=P₉P₈P₇P₆P₅P₄P₃P₂P₁P₀

One of the differences from the data encryption standard is that after the expansion function E, a key permutation is used. A 20-bit sub key, called a “permutation key” is used to swap E1 with E3 and E2 with E4. When the odd bits of the permutation key are set, they swap E1 relative bits with E3 bits, or they swap E2 relative bits with E4 bits. The outcome of this process is XORed with a 40-bit sub key and then fed into the S-boxes.

The S-boxes use Galois Field exponentiation. Each S-box takes a 10-bit input X. Bits X₉ and X₀ are concatenated to form the row selector R while bits X₈ to X₁ are concatenated to form the 8-bit column selector C. For each row, there is a XOR offset value O_{R} and a Galois Field prime P_{R}. The output of the S-box is an 8-bit value which is given by (C xor O_{R})⁷ mod P_{R}. The values of the XOR offset and the Galois Field primes can be seen for all four S-boxes:

| S-Box | O₀ | O₁ | O₂ | O₃ | P₀ | P₁ | P₂ | P₃ |
|---|---|---|---|---|---|---|---|---|
| S1 | 131 | 133 | 155 | 205 | 333 | 313 | 505 | 369 |
| S2 | 204 | 167 | 173 | 65 | 379 | 375 | 319 | 391 |
| S3 | 75 | 46 | 212 | 51 | 361 | 445 | 451 | 397 |
| S4 | 234 | 205 | 46 | 4 | 397 | 425 | 395 | 505 |

The four 8-bit outputs of the S-boxes are combined using a permutation function P in a 32-bit value, which is the result of the F function.

The present invention confers on a user the ability to select a file, encrypt it, download it over the internet to a remote location through a multi-threaded, tunneling, encrypted VPN, and then retrieve the same file as a remotely viewed object or upload it to a computer and view it as local data. All encryption and decryption happens at the end users computer to include remote viewing. In one preferred embodiment, the end user uses their bio-id as their personal access key. All other keys are generated randomly from multiple matrix files in random order using random key lengths, random block sizes, and random length keys from 256 to 1,000,000 bits. No matter how many keys are used, only 1 KB of data containing the encrypted pointers is transmitted for decryption, and the file can be decrypted with the right bio-access ID, and the correct set of matrix keys.

In one preferred embodiment of the present invention, the following code is used to initialize the 3-D quaternion quantum fractal encryption:

One of the unique features of the three-dimensional quaternion chaos fractal encryption of the present invention is that it does not completely depend on the strength of its keys. Each session is unique to the specific fractal or fractals upon which it was generated. It is also unique in that it provides the option to have public or private fixed keys, known back doors, or absolutely no back door formats at all.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

What is claimed is:

1. A method of encrypting computerized data comprising the steps of;
a. generating a three-dimensional image;
b. generating a random encryption key with parameters and pointers associated with data points within the fractal;
c. encrypting a file;
d. transmitting the encrypted file, and pointers;
e. regenerating the encryption key using the pointers and the three-dimensional quaternion quantum fractal image;
f. regenerating the three-dimensional quaternion quantum fractal image using the same parameters;
g. performing a search within the fractal image for the key string values;
h. regenerating

2. The method of claim 1, wherein the image is based on a randomly generated quaternion quantum chaos fractal.

3. The method of claim 1, wherein the fractal can be of infinite size and have an infinite number of occurrences for each of over twenty-five available variables.

4. The method of claim 3, wherein variables of the fractal image comprise: the shape of the area, color mapping, number of colors, exact shading of colors, resolution, precision, internal cubic mapping of the image, external cubic mapping of the image, cube root mapping of the image, acceleration, smoothing, wrapping, angle, offset, speed, step, Mandelbrot chaos base formula, number of passes, periodicity, elimination, critical point, bailout value, angles, and color cycling to include speed, stepping, and direction.

5. The method of claim 2, wherein variables affecting the image comprise horizontal light direction, vertical light direction, light diffusion, ambient light and reflected light, up/down transformations, multiplier transformations, y-stretch transformations, back multiplier transformations, open G1 data comprising view, distance, rotation and x/y parameters; and material parameters comprising secular, emission, color, alpha, shininess, and texture settings in spherical mode.

6. The method of claim 2, wherein each of the variables associated with the fractal is assigned a base sixteen value using a binary code between 00 and FF, and the binary values can be repeated an infinite number of times at infinite locations within the fractal with no repeating pattern

7. The method of claim 1, wherein when a single pixel is pinpointed, a random base 16 color code, identified by its binary value, is produced, and the random base 16 color codes are then converted to a standard Unicode format, generating keys to encrypt the data.

8. The method of claim 1, wherein the system automatically passes all data from point to point through an encrypted multi-threaded tunneling VPN using a different internally generated random encryption key for each VPN instance.

9. The method of claim 1, wherein only the pointers are transmitted with an encrypted file and not the actual keys.

10. The method of claim 9, wherein the data transmitted to regenerate the key is less than one kilobyte.

11. The method of claim 1, wherein the search performed inside the fractal is for the appropriate address pixels containing the first and last values in the key string.

12. The method of claim 11, wherein a set of pointers is created from the values of the key string indicating the pattern needed to navigate inside the fractal to generate all of the required keys to decrypt the data.

13. The method of claim 12, wherein a different fractal parameter set and pointers completely unrelated to the original data are used.

14. The method of claim 1, wherein any key can be any length.

15. The method of claim 1, wherein any number of keys can be used.

16. The method of claim 1, wherein each file is encrypted using a different randomly generated fractal containing completely different parameter values.

17. The method of claim 1, wherein the actual key is never exchanged, but rather merely referenced by parameters and pointers.

18. The method of claim 1, wherein the method employs a standard controlled permutation to maintain cryptographic security.

19. The method of claim 18, wherein the method uses a standard symmetric algorithm with true variable block sizes between 64 and 17,179,869,184 bits.

20. The method of claim 19, wherein encryption is varied using multiple keys between 128 to 256 bits

21. The method of claim 1, wherein the minimum size of the image is 256 pixels square, and is limited in size only by available memory and memory swap space.

22. The method of claim 1, wherein the encryption algorithm is a standard Feistel block cipher, which takes a 64-bit plaintext and splits it, creating two 32-bit halves, mixing those 32-bit pieces with nine variable length keys extracted from the quadratic matrix.

23. The method of claim 22, wherein the right 32-bit half and a 60-bit sub key are fed into the function F, the output XORed, and the left part of the key and the halves swapped in the transformation stage of the algorithm; wherein this process is repeated for 16 rounds, and the swap is omitted in the final round before the cipher text is produced.

24. The method of claim 22, wherein the 32-bit plaintext, using a function E, is expanded in four 10-bit values, and after the expansion function E, a 20-bit sub key is used to swap E1 with E3 and E2 with E4, wherein; when the odd bits of the sub key are set, they swap E1 relative bits with E3 bits, or they swap E2 relative bits with E4 bits resulting in an outcome that is XORed with a 40-bit sub key and then fed into the S-boxes.

25. The method of claim 24, wherein the S-boxes use Galois Field exponentiation, each S-box takes a 10-bit input X, bits X₉ and X₀ are concatenated to form the row selector R while bits X₈ to X₁ are concatenated to form the 8-bit column selector C, wherein; for each row, there is a XOR offset value O_{R} and a Galois Field prime P_{R} the output of the S-box is an 8-bit value which is given by (C xor O_{R})⁷ mod P_{R}, and the values of the XOR offset and the Galois Field primes can be seen for all four S-boxes:

26. The method of claim 25, wherein the four 8-bit outputs of the S-boxes are combined using a permutation function P in a 32-bit value, which is the result of the F function.
